(19) United States
(12) Patent Application Publication
(10) Pub. No.: US 2004/0027267 A1
(43) Pub. Date: Feb. 12, 2004

(54) 3D entertainment system

(76) Inventor: Armand M. Rousso, New York, NY (US)

Correspondence Address: Warren A. Sklar, Esq., Renner, Otto, Boisselle & Sklar, LLP, Nineteenth Floor, 1621 Euclid Avenue, Cleveland, OH, 44115, US

(21) Appl. No.: 10/395,018

(22) Filed: Mar. 21, 2003

Related U.S. Application Data
(60) Provisional application No. 60/366,825, filed on Mar. 22, 2002.

(51) Int. Cl. H01Q 17/00

(52) U.S. Cl. 342/1

(57) ABSTRACT

A system for selectively displaying images for viewing as three dimensional (3D) images or as two dimensional (2D) images that includes a stereoscopic 3D image processing system, a 2D-3D selector switch and a display capable of displaying both 2D images and stereoscopic 3D images. The stereo 3D image processing system can provide signals to operate the display based on input video signals, the status of the 2D-3D selector switch, and the type of display.

This application claims the benefit of U.S. Provisional Application No. 60/366,825, filed Mar. 22, 2002.

### TECHNICAL FIELD

This invention relates generally to apparatus and method for selectively displaying images for viewing as three dimensional (3D) images (stereoscopic images) or as two dimensional (2D) images, and to apparatus and method that will accept video input and output various formats of two dimensional (2D) and 3D information to be presented for viewing.

### BACKGROUND

Images viewed in a way that presents stereoscopic or 3D perception usually are more interesting and usually present more information to the viewer than two dimensional (2D) images. Various techniques have been used in the past to present and/or to view 3D images. Some prior systems have required lenses used as eye glasses to transmit sequentially to the respective eyes of a viewer (person) respective left and right eye images. Sometimes the lenses have been fixed polarized lenses, e.g., plane polarized or circularly polarized to transmit light having specified polarization characteristics; and sometimes the lenses have been active light shutters that respectively transmit or block light transmission. Early lenses were color filters.

Flicker has been a problem with prior 3D display systems. Conventional televisions and some computer monitors typically have run at only 60 HZ (Hertz) and flicker badly when displaying 3D images.

Various techniques have been used to convert 2D images to 3D images for display. Also, various techniques have been used to display 3D images along with appropriate synchronization signals for shutter glasses or for changing a polarization characteristic of the light from the display (e.g., television or monitor) to allow for left and right eye images to be viewed sequentially by respective left and right eyes of a viewer. Sometimes the equipment to do the mentioned conversion and/or to discern that a 3D image is being received and is to be displayed appropriately is in a “set top box” that would be placed on top or near a display (television or monitor) to provide from the received video signal, for example, the respective left and right eye images for display by the display as 3D images.

If the incoming video signal or data is intended to be 3D but for some reason a viewer is uninterested in viewing a 3D image, for example, because of eye strain that may be caused due to viewing 3D images, there has been no way in the past to “turn off” the 3D mode or selectively to switch between 2D and 3D modes, whether the 3D image arrives as a 3D image with sequential left and right images or as a 2D image for conversion to a 3D image. Also, in the past it has been unnecessary, impractical or impossible to switch between 2D and 3D image display modes for display, for example, in the case that a television was incapable of sufficiently fast refresh rates to avoid substantially intolerable flicker, e.g., faster than 60 Hz, or in the case that a computer monitor did not have an associated tuner for converting incoming video signals to signals suitable for display by the monitor.

Thus, there is a need in the art for an ability selectively to control whether an image is to be viewed in 2D or 3D mode.

### BRIEF SUMMARY OF THE INVENTION

With the above in mind, an aspect of the invention relates to providing the ability to select displaying of 2D and 3D images.

One or more of the above and other aspects, objects, features and advantages of the present invention are accomplished using the invention described and claimed below.

To the accomplishment of the foregoing and related ends, the invention, then, comprises the features hereinafter fully described and particularly pointed out in the claims. The following description and the annexed drawings set forth in detail certain illustrative embodiments of the invention. These embodiments are indicative, however, of but a few of the various ways in which the principles of the invention may be employed.

Although the invention is shown and described with respect to certain embodiments, it is understood that equivalents and modifications will occur to others skilled in the art upon the reading and understanding of the specification. The present invention includes all such equivalents and modifications, and is limited only by the scope of the claims.

### BRIEF DESCRIPTION OF THE DRAWINGS

In the annexed drawings:

FIG. 1 is a schematic block diagram of a 3D Entertainment System in accordance with the invention; and

FIG. 2 is a schematic block diagram of various inputs and outputs associated with the image processing system of the invention.

### DESCRIPTION

In the following detailed description, like parts are designated by like reference numerals in the several drawing figures.

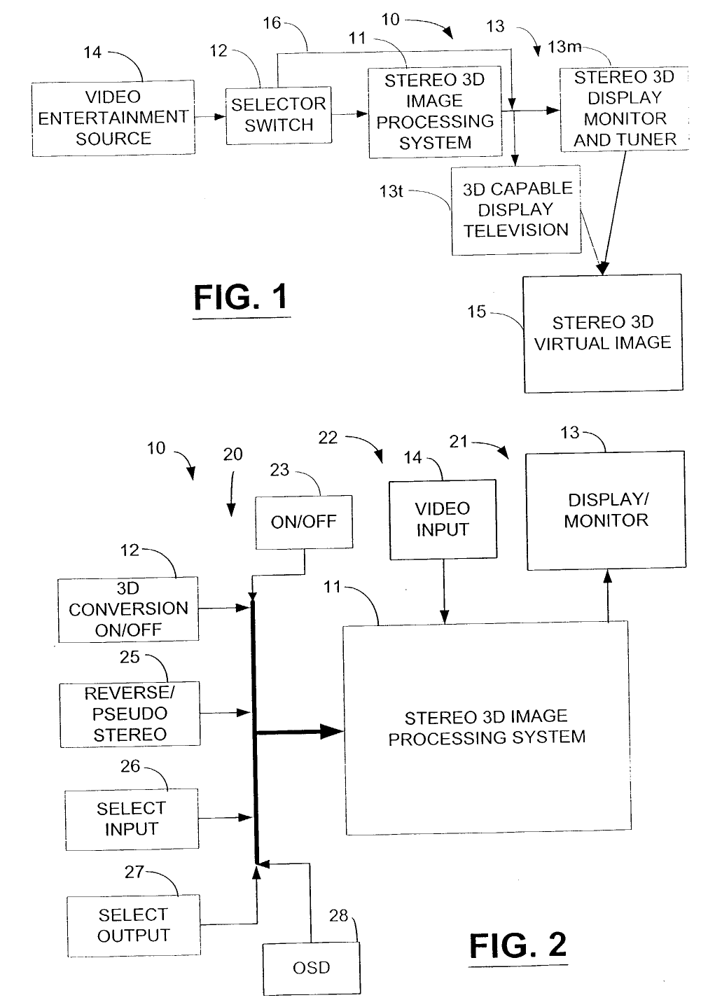

Referring, now, to the drawing figures, and initially to FIG. 1, a 3D entertainment system in which the invention may be employed is illustrated generally at 10. The system 10 includes a stereoscopic 3D image processing system 11, a 2D-3D selector switch 12, and display 13 capable of displaying both 2D images and stereoscopic 3D images. The display 13 may be, for example, a conventional computer monitor 13m having an integral tuner or an associated tuner to receive incoming video signals, e.g., via cable, antenna, satellite, playback device (tape-VCR, video disc-CD, digital video disc-DVD, etc), a television 13t capable of a sufficiently fast refresh rate, e.g., faster than 60 Hz (Hertz), for example, 85 Hz, 100 Hz or even faster, as to be able to display 3D images with less flicker than a 60 Hz refresh rate television, or other suitable display device. The display 13 may be a liquid crystal display, cathode ray tube, electroluminescent display, plasma display or other type of display.

The stereo 3D image processing system 11 provides signals to operate the display 13. Those signals may be signals that provide for displaying of 3D images, e.g., sequential left eye and then right eye images, etc. The stereo 3D image processing system 11 also may be operative to convert 2D images to 3D images; such conversion may be carried out, for example, by receiving signals representative of one or more 2D images and converting those signals to signals representative of corresponding 3D images that may be displayed sequentially to respective left and right eyes of a viewer, e.g., the user of the system 10.

A video entertainment source 14 provides input video signals to the stereo 3D image processing system. These input video signals may be from any of many different sources, such as, for example, a radio transmitted television signal, a cable television signal, internet, compact disc (CD), digital video disc (DVD), magnetic tape (VCR), or virtually any other source. The input video signals may represent a movie, a game, some type of broadcast, e.g., news, weather or like broadcast, educational information, e.g., a model of a molecule, building, musical instrument, dance steps, etc., or, as indicated, virtually any other information, image, etc.

As was indicated above, the 3D entertainment system 10 of the invention, including the stereo 3D image processing system 11, switch 12 and stereo 3D display 13, for example, processes the input video signals and provides them as an output via the display 13 so that a viewer can view a stereo 3D virtual image, which is represented in FIG. 1 at 15. The image may be displayed on an autostereoscopic monitor or on nearly any television, video monitor or other display.

The selector switch 12 may be virtually any type of switch. As an example, the selector switch 12 may be a switch that is thrown (operated) to determine whether the 3D entertainment system 10 will operate in a 2D or 3D mode. Operation of the selector switch 12 may be without regard to whether the incoming signals are 2D or 3D, especially if the stereo 3D image processing system 12 is able to convert 2D images to 3D images, e.g., left and right images created from a 2D image. The selector switch 12 may be a switch that directs signals from the source 14 directly via the conductor(s) or conductive path 16 to the display 13 or, alternatively, to the stereo 3D image processing system 11 from which signals are delivered to the display 13. The system may simply turn on or off the stereo 3D image processing system 11, whereby when it is on, it overrides any signals that otherwise would be directly sent from the selector switch 12 too the display 13, and when it is off it allows signals to go from the selector switch 12 to the display 13 thereby in effect bypassing the stereo 3D image processing system 11. It will be appreciated that the selector switch may be some other type of switch, circuit, or other device that determines in effect whether the output provided by a respective one of the displays 13 is provided as a 2D image or as a 3D image.

Turning to FIG. 2, the 3D entertainment system 10 is illustrated along with a number of control inputs 20 and the output 21 from the stereo 3D image processing system 11. The output 21 is to the display 12. A video input 22, for example, the video entertainment source 14 described above or from some other source, also is provided the 3D entertainment system 10. Exemplary video inputs 22 include composite video, S-Video, HDTV (high definition television), and/or other inputs. Exemplary outputs 21 may be composite video, S-Video, SVGA, HDTV, a signal and/or connection to 3D image viewing glasses, a transmitter, and/or a connector for coupling a signal to a transmitter. The SVGA signal may be provided at 100 Hz or at some other frequency that is suitable to avoid undesirable or intolerable flicker. The signal and/or connection to 3D image viewing glasses may be a signal that operates shutters or synchronizes shutters to permit left and right eye images from a display to be seen by a user; alternatively, such signal and/or connection may be a signal that operates respective displays, e.g., liquid crystal displays, in a goggle or eye glasses, to present images directly to a user. Connection may be provided to one set of lenses, shutters, displays, eye glasses, goggles, or simultaneously to several for use by several users. The synchronization signal or a driving or operating signal that is synchronized with the respective left and right eye images being provided by the display for viewing may be via direct electrical connection to the lenses, may be provided via an infrared or radio frequency link, etc. If desired, the synchronization signal may operate a polarization changing shutter at the display 13 in which case the glasses may be simply polarization selective filters, e.g., plane (linear) polarizers that are crossed or circular polarizers that are intended to pass respective direction of circularly polarized light.

Exemplary control inputs 20 to the image processing system 11 of the 3D entertainment system 10 are illustrated in FIG. 2. These control inputs include an on/off control, such as an on/off switch 23 or other power or control switch, etc. Another control input is a conversion control 24, e.g., the selector switch 12, which may be used to turn on or off a circuit or the like in the image processing system 11 to convert 2D images to 3D images or may be used as described above to determine whether respective images are 2D or 3D type. A reverse stereo or pseudo stereo switch 25 is able to switch the sequence of images provided to a user and/or to alter the manner of conversion of 2D to 3D images so that instead of an image appearing “out of the display” toward the user, the image appears “into the display” away from the user. Switches 26 and 27 may select the input to be used and the output to be active for the image processing system 11. Input 28 is for the OSD. In the above description reference is made to switches to provide control or control functions; it will be appreciated, though, that instead of switches appropriate signals, circuitry, detectors, sensors, controllers, computer interfaces, etc., may be used to provide the desired control input to the image processing system 11 to obtain the desired output therefrom.

With the above in mind, then, it will be appreciated that the invention provides the ability to selectively determine whether images are to be displayed in 2D or 3D mode. If a computer monitor is being used to receive 3D images represented by television type video signals, then the monitor may include a tuner or it may be connected to receive the signals via a tuner. If a television is used, it may have a relatively fast refresh rate to avoid flicker issues, as was described above. The incoming signals may be regular television signals broadcast via virtually any technique, such as radio signals picked up by an antenna, cable, satellite or any other way. The incoming signals may be from a reader that reads a compact disc or video disc (CD) or a digital video disc (DVD). The incoming signals may be received via the internet. One example is streaming video; but there may be many other types of signals received over the internet or over any other network, whether wired, operated via radio signals, satellite, etc. The incoming 3D type signals may be arranged in various formats, such as over/under, left/right, or interlaced or they may be in some other type of format. They may be simply sequentially provided left and right images. If desired, the images may be 2D type with a suitable system provided to convert the 2D image to a 3D image; examples of systems to do such conversions are available commercially and in PCT published patent application No. WO 01/76258 A2, published Oct. 11, 2001, and pending PCT patent application No. PCT/EP01/13674, both of which designate the United States of America, the entire disclosures of which are incorporated by this reference.

### INDUSTRIAL APPLICABILITY

The invention may be used to provide and to display images for viewing for various purposes.

F:\113\WAS\TDVT\P104USA\TDVTp104us_Fnl.wpd

What is claimed is:

1. A system for selectively displaying images for viewing as three dimensional (3D) images or as two dimensional (2D) images, comprising:
a video input for receiving image data, and
an output device for presenting at least one of two dimensional images and three dimensional images for viewing.

2. A method for selectively displaying images for viewing as three dimensional (3D) images or as two dimensional (2D) images, comprising:
receiving image data, and
presenting at least one of two dimensional images and three dimensional images for viewing.
